(19) United States
(12) Patent Application Publication
(10) Pub. No.: US 2019/0190286 A1
(43) Pub. Date: Jun. 20, 2019

(54) Charging sockets based on Internet of things (IoT)

(71) Applicant: Shenzhen Public Power Supply Technology Co., Ltd., Shenzeng (CN)

(72) Inventors: Haifeng Chen, Shenzhen (CN); Tao Liu, Shenzhen (CN)

(21) Appl. No.: 15/908,819

(22) Filed: Mar. 1, 2018

(30) Foreign Application Priority Data
Dec. 19, 2017 (CN) 201711373751.8

(51) Int. Cl. H02J 7/00; H01R 13/66; H04L 29/08; H04L 12/12

(52) U.S. Cl. CPC H02J 7/0031; H02J 7/0042; H04L 12/12; H01R 13/6683; H04L 67/125; H02J 7/007

(57) ABSTRACT

Techniques related to a smart charging socket based on the IoT are described. According to one embodiment, a charging socket includes a Narrow Band Internet of Things (NB-IoT) module, a main control MCU module, a measurement module, and a power supply module. The main control MCU module determines by comparing real-time data with a preset threshold. The measurement module obtains real-time parameters in or around the charging socket. A control circuit is added without changing the shape of the charging socket. A charging state of the socket is monitored in real time, and data is reported to a server in real time. If an abnormal state of the charging socket occurs, the charging socket is automatically cut off a power supply to ensure the safety and wellbeing of a user using the charging socket.

### BACKGROUND

### Technical Field

The present invention is related to the area of Internet of Things (IoT) technologies, and in particular, to a smart charging socket based on the IoT and may be used in charging stations for, for example, electric motorcycles, electric bicycles, electric tricycles, and low-speed electric automobiles.

### Related Art

The Internet of things (IoT) is the network of physical devices, vehicles, home appliances and other items embedded with electronics, software, sensors, actuators, and connectivity which enables these objects to connect and exchange data. Each thing is uniquely identifiable through its embedded computing system but is able to inter-operate within the existing Internet infrastructure. Many enterprises predict that the number of global IoT connections are in the range of hundreds of billions in the future. For example, IoT applications in Vehicles, smart health care and smart homes may create a large quantity of connections that far exceed communication requirements among people. In addition, operators and equipment vendors are providing complete IoT solutions and applications in different vertical industries.

A ubiquitous network connection is a basis to implement these solutions. Narrow Band Internet of Things (NB-IoT) based on a cellular becomes an important branch of an Internet of everything network. The NB-IoT is constructed in a cellular network, consumes only a bandwidth of approximately 180 KHz, and can be directly deployed in a GSM network, a UMTS network, or an LTE network, so as to reduce deployment costs and realize smooth upgrading.

The NB-IoT is focused on the low-power and wide-area (LPWA) IoT market, is an emerging technology that can be applied widely and globally, has characteristics such as wide coverage, multiple connections, low velocity, low costs, low power consumption, and good architecture, uses a licensed frequency band, and can use three deployment manners such as in band, guard band, or independent carrier to coexist with an existing network. In addition, the NB-IoT is an emerging technology in the field of IoT, supports a cellular data connection of low power devices in a wide area network, and is also referred to as low power wide area network (LPWAN). The NB-IoT supports a high-efficient connection of devices having a long standby time and high requirements on the network connection.

The NB-IoT has four characteristics. The first is wide coverage. The NB-IoT provides improved indoor coverage and has a gain of 20 dB compared with an existing network in the same frequency band. This is equivalent to improving an area covering capability by 100 times. The second is the capability to support a large quantity of connections. A sector of the NB-IoT can support a hundred thousand connections, and the NB-IoT supports low delay susceptibility, ultra-low device costs, low device power consumption, and an optimized network architecture. The third is low power consumption. A standby time of a terminal module of the NB-IoT can last for 10 years. The fourth is low module costs. A single connection module expected by enterprises does not exceed 5 dollars.

With these advantages such as low power consumption, wide coverage, low costs, and large capacity, the NB-IoT can be widely applied in various vertical industries such as remote meter reading, assets tracking, smart parking, smart agriculture, and smart electric appliances. As an example, the commercially available existing charging systems for electric vehicles are mainly operated based on the insertion of cashes (e.g., coins) and are controlled in centralized control boxes. Charging sockets of the charging systems are typically ordinary sockets, wires are led out from the centralized control boxes, and the centralized control boxes control on and off of the sockets and cannot sense detailed information of the sockets. Therefore, a charging system, if using a centralized control box, can provide only a basic charging service. There is a need for a charging system that can provide some safety and monitoring mechanisms. For example, if a charging device catches fire, the socket may still provide the power supply for charging because the socket would not sense the danger or the high temperature around the charging device in real time, which is indeed very dangerous.

The present invention provides techniques to address the above problems and many other problems.

### SUMMARY

This section is for the purpose of summarizing some aspects of the present invention and to briefly introduce some preferred embodiments. Simplifications or omissions in this section as well as in the abstract and the title may be made to avoid obscuring the purpose of this section, the abstract and the title. Such simplifications or omissions are not intended to limit the scope of the present invention.

Generally speaking, the present invention provides a smart charging socket operating based on the technologies of the IoT. According to one aspect of the present invention, the sockets used in one embodiment of the present invention include functions such as smart temperature control protection and electrical parameters measurement so as to provide more than just simply supplying power.

According to another aspect of the present invention, the present invention provides one or more following technical solutions: a smart charging socket based on IoT, where the charging socket is connected to an IoT smart management system, the smart charging socket includes a modular case including a cover with a front panel on which there is a two-dimensional code to be scanned by a user for charging his/her car. Depending on implementation, the two-dimensional code can be disposed near the socket or right on the front panel. The charging socket or a smart charging system further includes an NB-IoT module, a main control MCU module, a measurement module, and a power supply module. The main control MCU module is connected to a sensor unit configured to acquire a temperature state nearby, compares the real-time temperature state data with a preset threshold, and controls a relay to cut off a power supply if the real-time data exceeds the preset threshold. The measurement module is designed to obtain real-time voltages and currents of a neutral wire and a live wire by using an L wire current sample, an N wire current sample, and a voltage sample, and derives from the calculation based on each or all parameters of or around the socket. The main control MCU module reads a voltage state, a current state, and electrical quantity state by means of serial port communication of the measurement module, and reports the state information to a cloud platform by using a communications unit in real time.

According to still another aspect of the present invention, additional structures in the foregoing technical solutions further include one or more of the following elements. The power supply module of the smart charging system is powered by using a 5 V, 1 A switch-mode power supply, and the type of a chip of the power supply module is TB5806 according to one embodiment. The smart charging socket has a smart temperature control protection structure, a WIRE_DQ port of the main control MCU module of the smart charging system is docked with a temperature sensor module by using a DS18B20 interface, and a WIRE_DQ access port of the DS18B20 interface is directly connected to a pin of a DS18B20 chip.

A NETLIGHT port of the NB-IoT module is connected to a network indicator unit, one port of the NB-IoT module is connected to a circuit unit formed by J1, the circuit unit includes a TX_IN port and a TX_OUT port, and a capacitor C2 and a capacitor C3 are connected in parallel to a branch circuit formed between the two ports; and an NB PER port of the NB-IoT module is connected to a power-on circuit.

The foregoing technical solution and the technical solution having any one of the additional structures further include an NB_RXD port, an NB_TXD port, an NB_RESET port, an RI port, and a VCC5 port of the NB-IoT module are correspondingly connected to an NB_RXD port, an NB_TXD port, an NB_RESET port, an RI port, and a VCC5 port of the main control MCU module, respectively; a GND port, a VCC3.3 port, an RXD port, a TXD port, a ZX port, a CB_JC port, and a JD_JC port of the main control MCU module are correspondingly connected to a GND port, a VCC3.3 port, an RXD port, a TXD port, a ZX port, a CB_JC port, and a JD_JC port of the measurement module, respectively; a LIN port, a VDD3.3 port, and a GNDP port of the measurement module are correspondingly connected to a LIN port, a VDD3.3 port, and a GNDP port of the power supply module, respectively; and a GND port, a VCC3.3 port, and a VCC5 port of the power supply module are correspondingly connected to the GND port, the VCC3.3 port, and the VCC5 port of the main control MCU module, respectively.

Further, for data transmission between the smart charging socket and the IoT smart management system, the main control MCU module performs calculation and then sends a result to a server, and the main control MCU module includes an automatic control system configured to receive various data to perform controlling, a network data parsing system, a real-time data acquisition system, and a data sending system. Correspondingly, the real-time information of each parameter includes, but is not limited to, a voltage, a current, an active power, a reactive power, an apparent power, and an electrical quantity.

In addition, a RELAY port of the main control MCU module is connected to a relay control circuit, an LCOUT port of the relay control circuit is a measured power supply live wire inlet, and an LOUT port is a live wire outlet connected to an L port of an AC socket. Preferably, the cover and the modular case both use a same standard to match, and a lightning protection unit, a current leakage protection unit, a short circuit protection unit, an overheat protection unit, an overvoltage protection unit, an overload protection unit, a ground protection unit, and a plugging detection unit are added to the module.

Beneficial effects of the smart charging socket based on IoT of the present invention include:

(1) By using the smart charging socket operated by using an IoT mode, a control circuit is added without changing the shape of a socket to change the socket to a smart socket having a corresponding control unit, a communications system, a measurement system, and a safety mechanism protection function.

(2) According to different use requirements, functions such as lightning protection, current leakage protection, short circuit protection, overheat protection, overvoltage protection, overload protection, ground protection, and plugging detection can be added to each socket, which helps to prevent over-charge, detect a charging curve of a battery in real time, and automatically cut off the power supply when the battery is fully charged.

(3) The temperature of the socket can be detected in real time by using a temperature detection part, and when the temperature is detected to rise excessively quickly and exceeds the normal charging temperature, the socket can automatically cut off the power supply to protect a charging device, and report temperature information of the socket in real time to a monitoring cloud platform.

(4) By using the convenient and safe charging system, a user can charge by scanning the two-dimensional code; the smart socket monitors a charging state in real time and reports data to the server in real time, and if an abnormal state occurs, the smart socket automatically cuts off the power supply to ensure the user's safety.

The present invention may be implemented as an apparatus, a method, a part of system. Different implementations may yield different benefits, objects and advantages. In one embodiment, the present invention is a charging socket operating on Internet of Things (IoT) and provided for charging an apparatus, the charging socket comprises: a sensor unit acquiring a plurality of parameters when the charging socket is engaged in charging the apparatus; a microcontroller, coupled to the sensor unit, executing a control program to determine if any of the parameters exceeds a predefined threshold; a relay, controlled by the microcontroller, provided to shut off operation of the socket when one of the parameters exceeds the predefined threshold; and a network interface to transport a status of the operation to a designated server.

According to another embodiment, the present invention is a charging socket operating on Internet of Things (IoT) and provided for charging an apparatus, the charging socket comprises: a sensor unit acquiring a plurality of parameters when the charging socket is engaged in charging the apparatus; a network interface; a microcontroller, coupled to the sensor unit and the network interface, executing a control program to send the parameters to a designed server over a network via the network interface; and a relay, controlled by the microcontroller, provided to shut off operation of the socket upon an instruction when the microcontroller receives the instruction from the server, wherein the server creates the instruction when one of the parameters exceeds the predefined threshold.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 is a perceptive view of a smart charging socket according to an embodiment of the present invention;

FIG. 2 is a schematic diagram of an exemplary bottom of a smart charging socket according to an embodiment of the present invention;

FIG. 3 is a schematic diagram of a cover of a smart charging according to an embodiment of the present invention;

FIG. 4 is a schematic flowchart or process of a smart charging socket according to an embodiment of the present invention;

FIG. 5 is a block diagram of wire connections among chips used in an exemplary smart charging socket according to an embodiment of the present invention;

FIG. 6 is a schematic diagram of an exemplary NB-IoT circuit module that may be used in a smart charging socket according to an embodiment of the present invention;

FIG. 6.1 is a schematic connection diagram of a power-on circuit that may be used in a smart charging socket based on IoT according to an embodiment of the present invention;

FIG. 6.2 is a schematic connection diagram of a network indicator circuit that may be used in a smart charging socket to an embodiment of the present invention;

FIG. 7 is a schematic diagram of a power circuit module that may be used in the smart charging socket according to an embodiment of the present invention;

FIG. 8 is a schematic diagram of an exemplary main control MCU module that may be used in a smart charging socket according to an embodiment of the present invention;

FIG. 8.1 is a schematic diagram of an interface circuit for connecting a main control MCU module and an NB-IoT circuit module in a smart charging socket according to an embodiment of the present invention;

FIG. 8.2 is a schematic connection diagram of a main control MCU module and a relay control circuit module in a smart charging socket according to an embodiment of the present invention;

FIG. 8.3 is a schematic connection diagram of a main control MCU module and a buzzer circuit module in a smart charging socket according to an embodiment of the present invention;

FIG. 8.4 is a schematic diagram of an exemplary circuit of a DS18B20 interface for connecting a main control MCU module to a temperature sensor circuit module according to an embodiment of the present invention;

FIG. 9 is an exemplary block diagram of a smart charging socket according to an embodiment of the present invention;

FIG. 10.1 is a schematic connection diagram of a current sampling circuit of an L wire that may be used in FIG. 9;

FIG. 10.2 is a schematic connection diagram of a current sampling circuit of an N wire that may be used in FIG. 9;

FIG. 10.3 is a schematic connection diagram of a voltage sampling circuit that may be used in a smart charging socket according to an embodiment of the present invention;

FIG. 10.4 is a schematic connection diagram of a plugging detection circuit that may be used in a smart charging socket according to an embodiment of the present invention; and

FIG. 10.5 is a schematic connection diagram of a measurement detection terminal circuit that may be used in FIG. 9 in a smart charging socket according to an embodiment of the present invention.

### DETAILED DESCRIPTION OF THE PREFERRED EMBODIMENTS

The detailed description of the invention is presented largely in terms of procedures, steps, logic blocks, processing, or other symbolic representations that directly or indirectly resemble the operations of data processing devices coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or diagrams representing one or more embodiments of the invention do not inherently indicate any particular order nor imply any limitations in the invention.

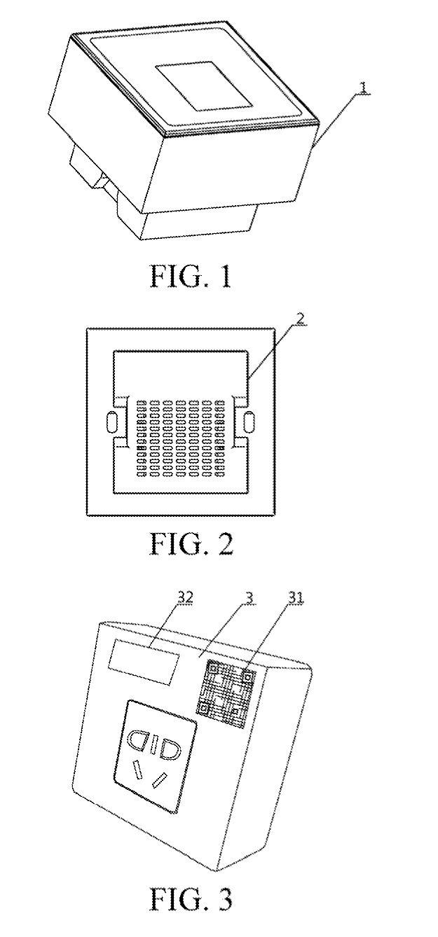

Embodiments of the present invention are discussed herein with reference to FIGS. 1-10.5. However, those skilled in the art will readily appreciate that the detailed description given herein with respect to these figures is for explanatory purposes as the invention extends beyond these limited embodiments.

Referring now to FIG. 1 to FIG. 3, each shows a view of an exemplary smart charging socket according to embodiments of the present invention. One of the objects in the present invention is to monitor, based on the IoT, various states of the socket in real time by using a data network so as to increase safety when the charging socket is in operation (e.g., charging an electronic vehicle). An exemplary structure of the socket includes a modular case 1, and a corresponding circuit implemented inside the modular case 1. According to one embodiment, the charging socket uses a three-core copper wire of 2.5 square millimeters, a three-core copper wire of 6 square millimeters, and the like, and further includes components such as a slot and a circuit breaker.

The modular case 1 includes a front panel and a back (rear) panel. As shown in FIG. 2, the back panel includes a heat dissipation plane designed to improve the heat dissipation from the socket. FIG. 3 shows an exemplary front panel 3. According to one embodiment, the panel or cover 3 includes a two-dimensional code 31 and a dedicated area 32 for advertising. The two-dimensional code 31 is preferably disposed adjacent to a jack so that a user can start to use the charging socket by using a smartphone to scan the two-dimensional code 3 (e.g., for payment). In addition, the area 32 used for advertising may be disposed adjacent to the two-dimensional code 31 or another portion of the cover 3 depending on implementation.

In one embodiment, both of the rear cover 2 and the front cover 3 use the same material (e.g., a standard) to match a special requirement. For example, the covers use an 86 type plastic material with a size of 86 mm×86 mm, the spacing between the two holes is defined to be 60 mm, for example, per a CD810 series and CD820 series of a Delexi switch socket.

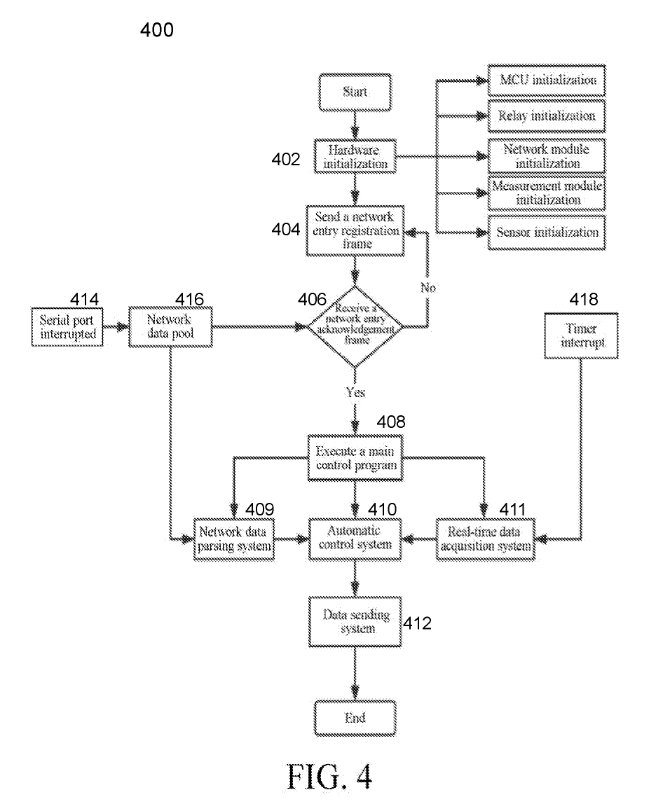

FIG. 4 shows a flowchart or process 400 of working flows in the socket show respectively FIGS. 1-3 according to one embodiment of the present invention. Briefly speaking, the socket includes a plurality of components to collect various data, and send the data to a server, where the server is designed to perform various calculations or comparisons to ensure all the collected data from the socket or derived data therefrom are within a predefined range (considered “normal”). If one of the data is deemed abnormal, an instruction is sent to the socket to shut off the operation of the socket to avoid any danger that may result from continued use of the socket.

According to one embodiment of the present invention, a control system implemented within the socket and performs a set of predefined calculations or comparisons and then sends a result to the server. In operation, the socket is designed to send network entry registration information after the socket is powered on. The entry registration may include a sequence number from which the server can be informed where the socket is located, when it starts to operate, and etc. In one implementation, a control program is executed to start monitoring the state of the socket after a network entry acknowledgement signal is received in the server. Logically, the control system includes an automatic control unit, a network data parsing unit, a real-time data acquisition unit, and a data transceiver. The automatic control unit is designed to receive various data to perform the controlled operation of the socket. The network data parsing unit is responsible for parsing data from the server. The real-time data acquisition unit is responsible for acquiring various data about the socket and sending the data to the control unit. The data sending transceiver is responsible for sending a result to the server after the control system performs the necessary calculations or comparisons.

The process 400 starts with hardware initialization 402. In operation, when the socket is initially powered up, some of the main components such as MCU. Relay, network module, measurement module and sensors are initialized. The control system in the socket is designed to send some parameters to the server at 404. The process 400 determines if the registration 404 is successful or not. It the registration 404 is determined at 406 not successful, the registration 404 is repeated after a certain period. It is now assumed that the registration 404 is successful, the process 400 now goes to 408, where the control program is executed in the socket. The control program is designed to manage the operations of the automatic control unit 409, the network data parsing unit 410 and the real-time data acquisition unit 411, for registration as described above. At 412, the collected data or a derived data set from the collected data is transported to the server, where the server is designed to make a decision from the collected data or achieve the status of a particular socket identified by a registration number in the registration 404.

In one embodiment, the main control MCU module communicates with a serial port 414 of a measurement and detection unit to read voltage state information, current state information, and electrical quantity state information, and reports the state information to a cloud platform by using a communications unit in real time. In addition, the cloud platform may also directly deliver a control instruction to directly control on and off of the relay.

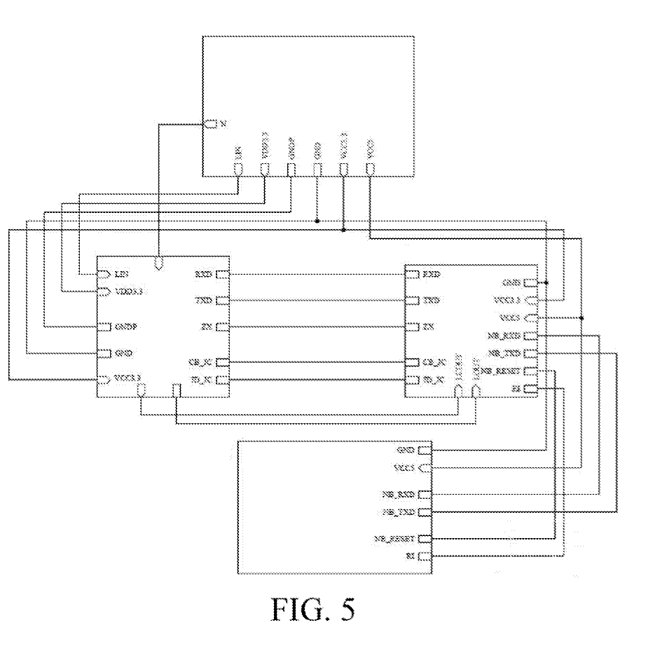

Referring now to FIG. 5, it shows a block diagram of several integrated circuits (ICs) working together to deliver one or more results contemplated in one embodiment of the present invention. FIG. 5 shows that diagram includes an NB-IoT module, a main control MCU module, a measurement module, and a power supply module, all are disposed inside the socket. The modules form a smart charging system, and corresponding modules obtain power from a power cable. A 5 V, 1 A switch-mode power supply is used to energize the operations of various parts and modules in the socket.

As shown in FIG. 5, an NB_RXD port, an NB_TXD port, an NB_RESET port, an RI port, and a VCC5 port of the implemented NB-IoT module are correspondingly connected to an NB_RXD port, an NB_TXD port, an NB_RESET port, an RI port, and a VCC5 port of the main control MCU module, respectively.

Correspondingly, a GND port and a VCC3.3 port of the implemented main control MCU module are correspondingly connected to a GND port and a VCC3.3 port of the implemented measurement module, and an RXD port, a TXD port, a ZX port, a CB_JC port, and a JD_JC port of the main control MCU module are correspondingly connected to an RXD port, a TXD port, a ZX port, a CB_JC port, and a JD_JC port of the measurement module, respectively.

Further, a LIN port, a VDD3.3 port, and a GNDP port of the implemented measurement module are correspondingly connected to a LIN port, a VDD3.3 port, and a GNDP port of the implemented power supply module, respectively. A GND port, a VCC3.3 port, and a VCC5 port of the implemented power supply module are correspondingly connected to the GND port, the VCC3.3 port, and the VCC5 port of the implemented main control MCU module, respectively.

As shown in FIG. 9, FIG. 10.1, FIG. 10.2, FIG. 10.3, FIG. 10.4, and FIG. 10.5, the charging system formed by the modules, according to one embodiment of the present invention, controls the entire socket by using the main control MCU module. The main control MCU module is connected to a sensor unit configured to acquire various state information such as the temperature. In operation, the main control MCU module compares real-time data with a preset threshold, and controls a relay to cut off a power supply if the real-time data exceeds the preset threshold. The measurement module obtains real-time voltages and currents of a neutral wire and a live wire by using an L wire current sample, an N wire current sample, and a voltage sample. A sampling resistor of the L wire current sample uses a manganin resistor. The measurement module obtains, through calculations by using a dedicated measurement chip, various data, such as a real-time voltage, a current, an active power, a reactive power, an apparent power, and an electrical quantity of the socket. The main control MCU module communicates with a serial port of a measurement and detection unit to read voltage state information, current state information, and electrical quantity state information, and reports the state information to a cloud platform by using a communications unit in real time. In addition, the cloud platform may also directly deliver a control instruction to directly control on and off of the relay.

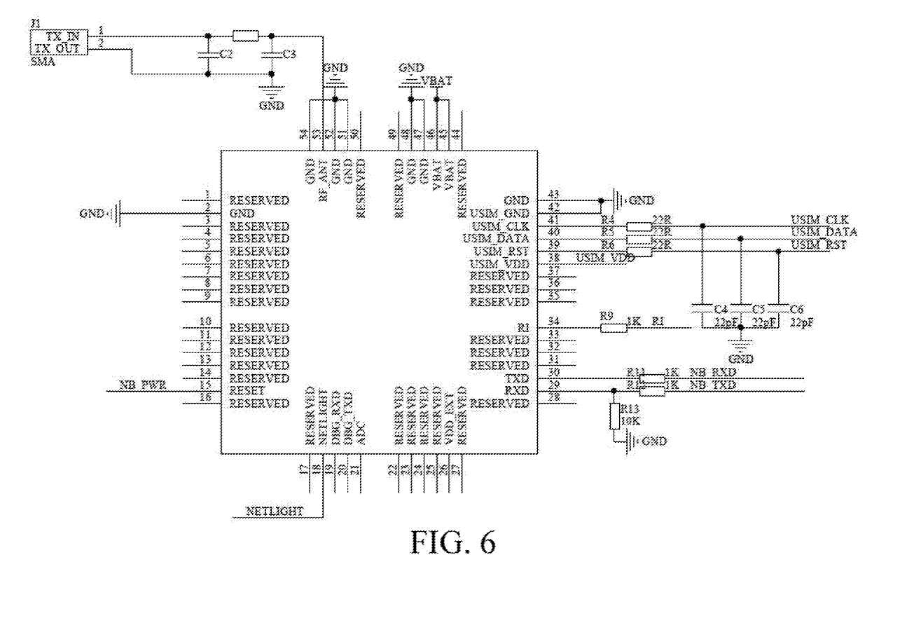

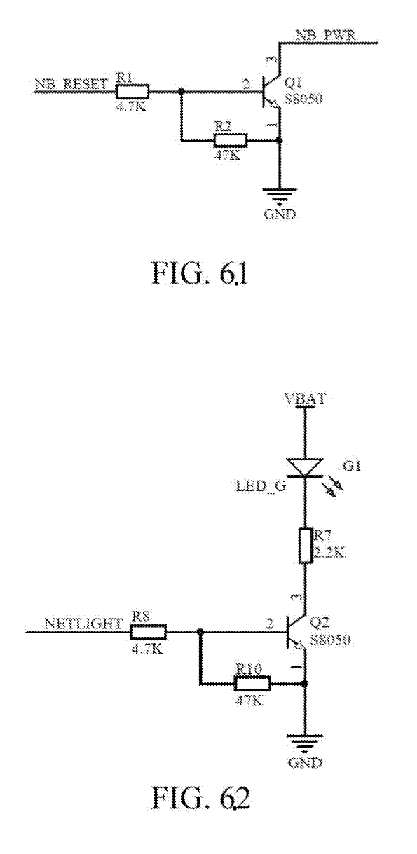

As shown in FIG. 6, FIG. 6.1, and FIG. 6.2, a circuit in the NB-IoT module is further implemented and may be used in the block diagram shown in FIG. 5, where each corresponding connection port is indicated in FIG. 6. A NETLIGHT port is connected to a corresponding network indicator unit. The implemented network indicator unit has an S8050-type Q2 and the triode Q2 is connected to a light-emitting diode G1 by using a resistor having a resistance of 2.2 K. An NB PER port of the NB-IoT module is configured to be connected to a power-on circuit. In the power-on circuit, the NB PER port is directly connected to a collector of a triode Q1, and a base of the triode Q1 is connected to a resistor R1 having a resistance of 4.7 K and then is connected to an NB RESET port. Correspondingly, a 53 port of the NB-IoT module is connected to a circuit unit formed by J1. The circuit unit includes a TX_IN port and a TX_OUT port, and a capacitor C2 and a capacitor C3 are connected in parallel to a branch circuit formed between the two ports.

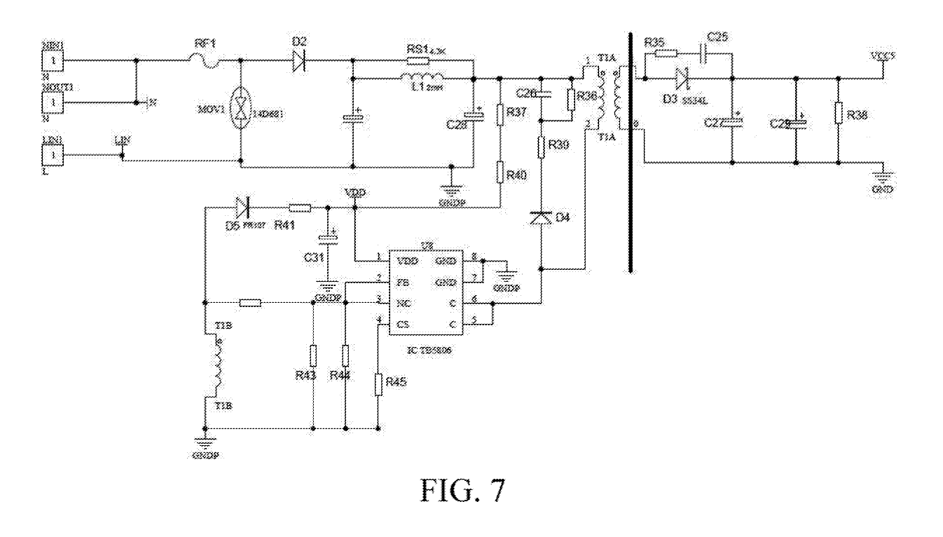

As shown in FIG. 7, a 5 V/1 A circuit of the power supply module using a chip TB5806 is further implemented in one embodiment. A sixth pin of the chip is connected in parallel to a diode D4, a serial connected branch circuit having the D4 is directly connected in series to an R39 and a C26. An L1, a D2, and an RF1 are added to a circuit connected to the serial connected branch circuit, and a MOV1 is connected to an RF1 branch circuit.

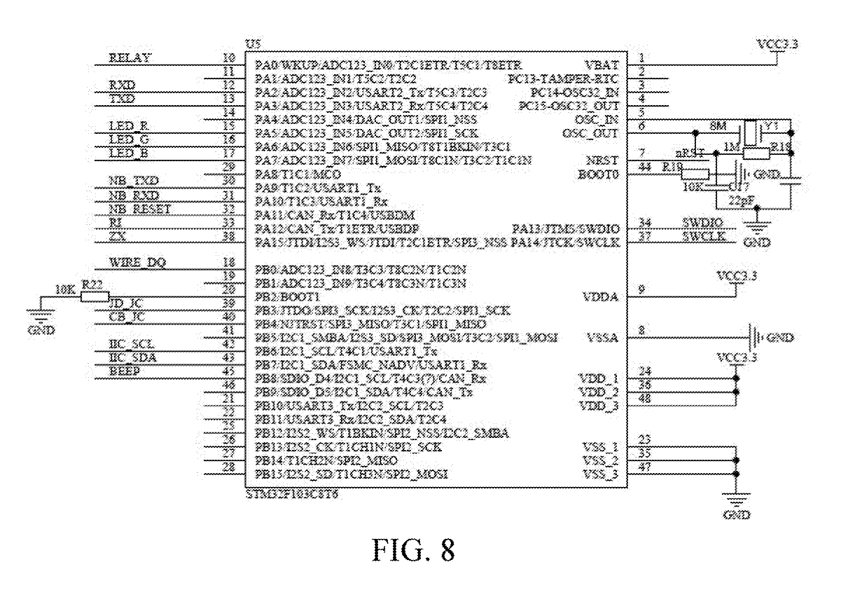

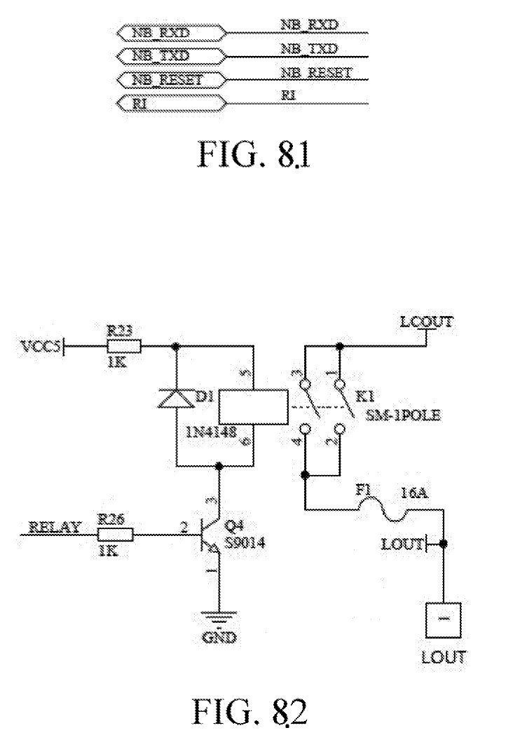

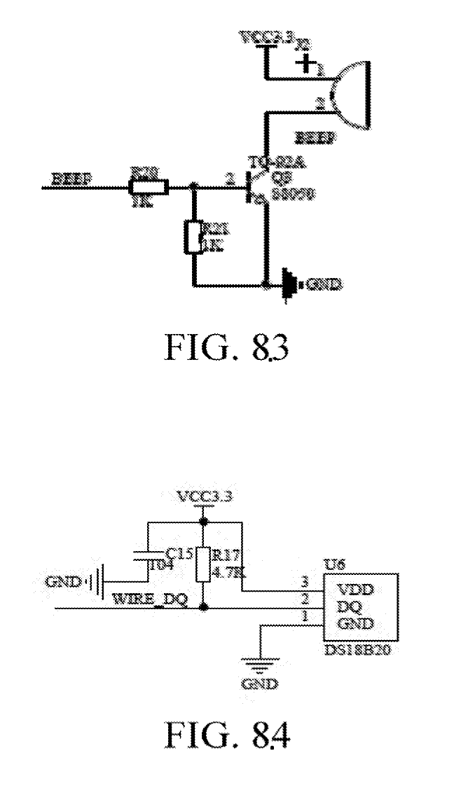

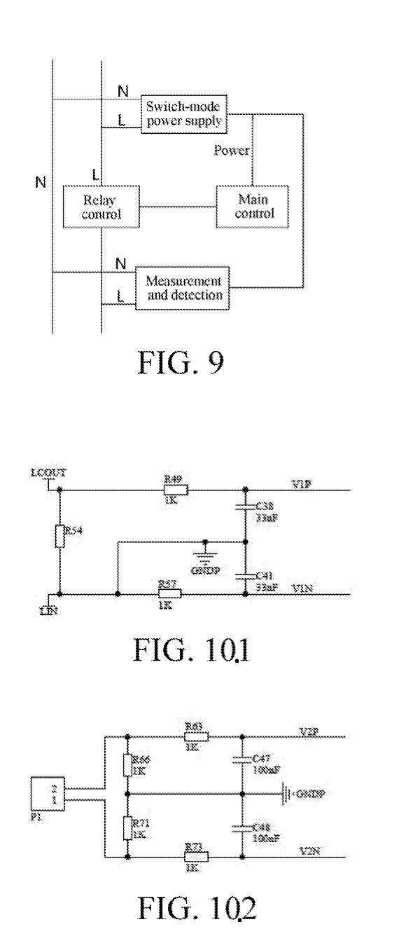

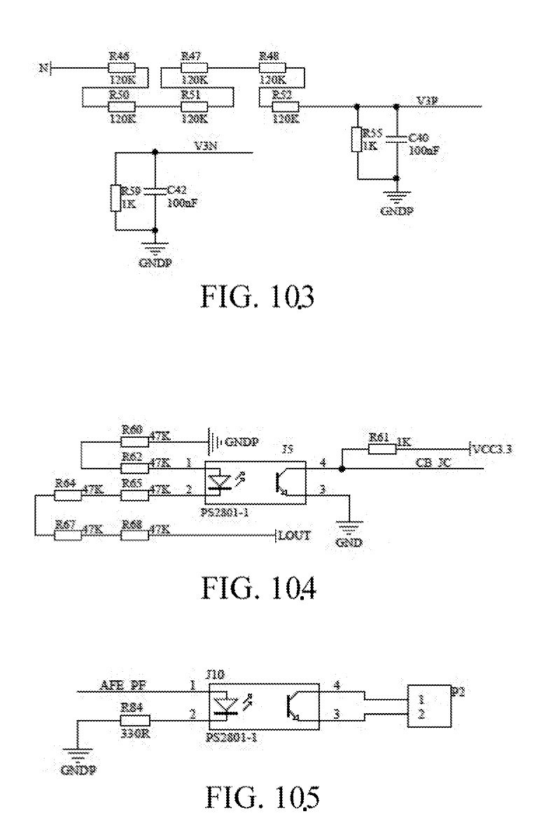

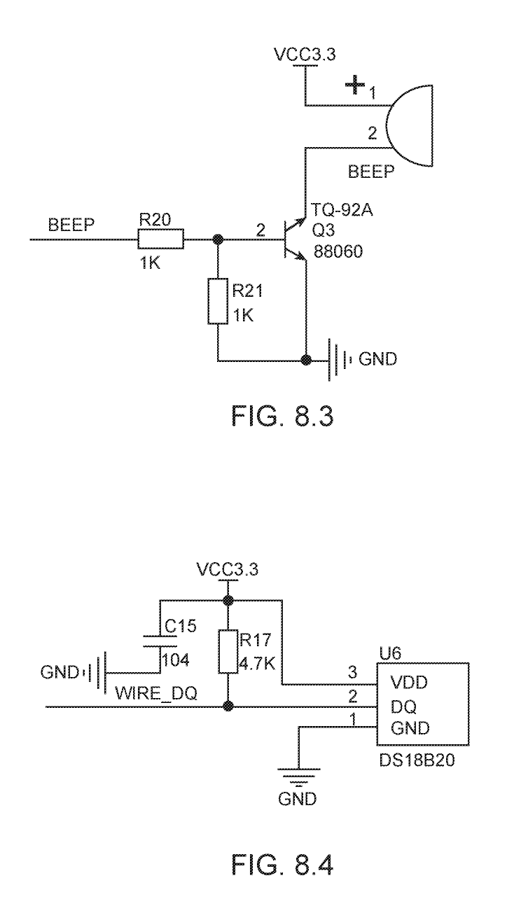

As shown in FIG. 8, FIG. 8.1, FIG. 8.2, FIG. 8.3, and FIG. 8.4, an implementation of the main control MCU module is further shown in one embodiment. The NB_TXD port, the NB_RXD port, the NB_RESET port, and the RI port of the main control MCU module are sequentially connected to corresponding ports shown in FIG. 8.1 respectively so as to form an interface circuit configured to connect the main control MCU module and the NB-IoT circuit module.

A RELAY port of the main control MCU module is connected to an S9014-type triode Q4 by using a resistor R26 having a resistance of 1K. A collector of the Q4 is connected in parallel to a 1N4148 and a diode D1 separately, a switch K1 of the 1N4148 is connected to an LCOUT, and the 1N4148 is connected to the LCOUT by using an F1. Correspondingly, the implemented LCOUT is a measured power supply live wire inlet, and the LOUT is a live wire outlet connected to an L port of an AC socket, so that the RELAY port is connected to a relay control circuit.

A BEEP port of the main control MCU module is connected to a circuit of a buzzer. A BEEP access port is connected to a S8050-type triode Q3 by using a resistor R20 having a resistance of 1 K, and a collector of the Q3 is directly connected to a second port of the buzzer.

A WIRE_DQ port of the main control MCU module is connected to a DS18B20 interface of a temperature sensor module. A WIRE_DQ access port is directly connected to a second pin of a DS18B20 chip, and a third pin of the DS18B20 chip is connected to a C15.

In the description of this specification, the terms “connection”, “installation”, “fixing”, “disposing”, “having”, and the like should be generally understood. For example, “connection” may be a fixed connection, may be indirectly performed by using intermediary components without affecting a member relationship and a technical effect, or may be an integral connection or a partial connection. For persons of ordinary skill in the art, in cases such as this example, specific meanings of the foregoing terms in the present invention or an invention may be understood according to specific cases.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

We claim:

1. A charging socket operating on Internet of Things (IoT) and provided for charging an apparatus, the charging socket comprising:
a sensor unit acquiring a plurality of parameters when the charging socket is engaged in charging the apparatus;
a microcontroller, coupled to the sensor unit, executing a control program to determine if any of the parameters exceeds a predefined threshold;
a relay, controlled by the microcontroller, provided to shut off operation of the socket when one of the parameters exceeds the predefined threshold; and
a network interface to transport a status of the operation to a designated server.

2. The charging socket as recited in claim 1, wherein the parameters include at least a temperature, a voltage and a current.

3. The charging socket as recited in claim 2, further comprising:
a front panel including a two-dimensional code to be scanned by a user to start the operation of the socket.

4. The charging socket as recited in claim 3, further comprising:
a rear panel including a heat dissipation plane to improve heat dissipation from the socket.

5. The charging socket as recited in claim 3, wherein the front panel includes a designated area for placing an advertisement, the designated area is adjacent to the two-dimensional code.

6. The charging socket as recited in claim 5, wherein the two-dimensional code is coated onto the front panel.

7. The charging socket as recited in claim 2, wherein the temperature is obtained around the charging socket, the voltage is a charging voltage the charging socket is supplying, and the current is a charging current the charging socket is supplying.

8. The charging socket as recited in claim 7, wherein the relay cuts off the charging voltage and/or the charging current when one of the parameters exceeds the predefined threshold.

9. The charging socket as recited in claim 8, further comprising a measurement module designed to obtain readings on real-time voltages and currents of a neutral wire and a live wire in the charging socket by using an L wire to sample the voltages and currents, wherein the L wire uses a manganin resistor.

10. A charging socket operating on Internet of Things (IoT) and provided for charging an apparatus, the charging socket comprising:
a sensor unit acquiring a plurality of parameters when the charging socket is engaged in charging the apparatus;
a network interface;
a microcontroller, coupled to the sensor unit and the network interface, executing a control program to send the parameters to a designed server over a network via the network interface;
a relay, controlled by the microcontroller, provided to shut off operation of the socket upon an instruction when the microcontroller receives the instruction from the server, wherein the server creates the instruction when one of the parameters exceeds the predefined threshold.

11. The charging socket as recited in claim 10, wherein the parameters include at least a temperature, a voltage and a current.

12. The charging socket as recited in claim 11, further comprising:
a front panel including a two-dimensional code to be scanned by a user to start the operation of the socket.

13. The charging socket as recited in claim 12, further comprising:
a rear panel including a heat dissipation plane to improve heat dissipation from the socket.

14. The charging socket as recited in claim 12, wherein the front panel includes a designated area for placing an advertisement, the designated area is adjacent to the two-dimensional code.

15. The charging socket as recited in claim 14, wherein the two-dimensional code is coated onto the front panel.

16. The charging socket as recited in claim 11, wherein the temperature is obtained around the charging socket, the voltage is a charging voltage the charging socket is supplying, and the current is a charging current the charging socket is supplying.

17. The charging socket as recited in claim 16, wherein the relay cuts off the charging voltage and/or the charging current when one of the parameters exceeds the predefined threshold.

18. The charging socket as recited in claim 17, further comprising a measurement module designed to obtain readings on real-time voltages and currents of a neutral wire and a live wire in the charging socket by using an L wire to sample the voltages and currents, wherein the L wire uses a manganin resistor.
